(19) United States
(12) Patent Application Publication
(10) Pub. No.: US 2010/0200024 A1
(43) Pub. Date: Aug. 12, 2010

(54) APPARATUS AND METHOD FOR PURGING PARTICLES FROM AN ACTUATOR

(75) Inventor: Jeffery R. Norris, Lebanon, OH (US)

Correspondence Address: WOOD, HERRON & EVANS, LLP, 2700 CAREW TOWER, 441 VINE STREET, CINCINNATI, OH, 45202, US

(73) Assignee: The Sheffer Corporation, Cincinnati, OH (US)

(21) Appl. No.: 12/369,387

(22) Filed: Feb. 11, 2009

(51) Int. Cl. B08B 3/04

(52) U.S. Cl. 134/34; 134/182; 134/183

(57) ABSTRACT

An apparatus for removing particles from a shaft includes a housing having a bore that receives the shaft. The housing includes an inlet port coupled to a pressurized fluid supply, a manifold chamber in communication with the inlet port, and a plurality of bores in communication with the manifold chamber and adjacent the shaft such that the fluid flowing through the bores impinges on the shaft. The bores are angled to produce a spiraling flow pattern about the shaft. A method of removing particles from a shaft includes directing a flow of a fluid onto the surface of the shaft in a generally spiraling pattern, and removing particles from the shaft using the spiraling flow.

### TECHNICAL FIELD

This invention relates generally to actuators, and more particularly, to an apparatus and method for purging particles or other contaminants from the actuator utilizing a fluid stream so as to extend the useful life of the actuator.

### BACKGROUND

In many industrial and commercial applications, there is a need for an actuator to act repetitively and over extended periods of time without the need for maintenance. By way of example, such actuators include linear type actuators wherein mechanical motion is achieved using a movable member, such as a shaft, that is extendable into and out of a housing. Examples of such linear actuators include pneumatic and hydraulic cylinders that are commonly used in a host of industrial applications and generally well known in the art. Conventional actuators include a device, often referred to as a gland set, which is designed to isolate the internal components of the housing from the external environment of the actuator. To this end, the gland set typically includes one or more wiper, one or more seal, and one or more bearing, and may be disposed near the end of the housing adjacent to where the shaft extends. The wiper(s) is(are) configured to wipe or remove debris from the shaft as the external portion of the shaft is moved back or withdrawn into the housing. In many actuators, the housing may include a fluid (e.g., oil, water, air, or other liquids or gases) to facilitate operation of the actuator. In these designs, the seal(s) is(are) configured to prevent the leakage of the operating fluid outside of the housing, such as along the interface between the housing and the extendable shaft. Lastly, the bearing(s) is(are) configured to support the shaft relative to the housing, especially adjacent the opening in the housing from which the shaft extends, during operation of the actuator.

Actuators of this type are often used in harsh industrial environments. For example, actuators of this type may be used in dirty environments having particulate matter and other contaminants or debris in immediate contact with the actuator, and/or may be operating in extreme temperature ranges (e.g., either extreme hot or cold environments). One such application, for example, is in the processing of raw materials for the aluminum smelting industry. In this industry, each pot line may include a large number of pots (e.g., often several hundred, if not thousands), with each pot typically including several actuators (e.g., two, three or four actuators) for manipulating the pot during operation. The environment is typically dirty (e.g., a large number of air borne particles contacting the actuator) and the temperatures at some installations may typically reach as high as about 400° F. under normal operating conditions.

Under such harsh conditions, the working life of the actuator may be considerably shortened. For example, in the aluminum smelting industry, the working life of an actuator is often limited to about five years, or sometimes expressed as little as about two million complete cycles of the actuator. Upon failure, the actuators typically require extensive maintenance and/or replacement, which is costly and time consuming. Thus, manufacturers are continually striving to improve the working life of actuators.

It is believed that the working life of the actuator is, in large part, determined by the gland set. More particularly, it is believed that the working life of the gland set is, in a large part, determined by the ability of the wiper(s) to effectively remove particles and other debris from the external portion of the shaft as the shaft is being moved back into the housing. In this regard, and in the normal course, the wiper(s) removes a high proportion of the particles from the surface of the shaft and those particles do not damage or otherwise affect proper operation of the actuator. However, even when all of the components are new, particles or contaminants remain present in the surrounding environment. These particles may settle onto the outer surface of the shaft and be of such size as to settle within the texture and imperfections in the shaft surface, and then travel through all of the components in the gland set. As the wiper(s) begins to wear, the problem may become even more exacerbated and a greater quantity of even larger particles may not be removed as the shaft passes by the wiper(s). It is believed that such particles have an undesirable effect on the actuator and ultimately result in its failure.

In this regard, the particles that do not get removed from the shaft as it is being withdrawn may be carried back into the housing and released therein as system contamination. These particles may undesirably affect the operation of the actuator, such as by eroding the seal between the piston and cylinder wall. Alternatively, the particles may get transferred from the shaft to the surface of the wiper(s), seal(s) or bearing(s) within the gland set. In this case, these components may become permanently abrasive resulting in increased and excessive wear on the shaft. In another scenario, the particles may become permanently embedded within the micro-surface structure of the shaft (e.g., between the peaks and valleys of the shaft material), such as in a so-called first pass of the shaft through the wiper(s), seal(s) or bearing(s). In this case, the shaft itself becomes permanently abrasive resulting in increased and excessive wear on the gland set components. These various behaviors of the particles appear to be random and dependent on the type of surfaces generated when the components are manufactured (e.g., smooth or rough), the type of particles or contaminants present in the environment during operation of the actuator, and/or other factors.

In any event, the result of particles not being removed from the shaft as the shaft is being withdrawn into the housing is increased and excessive wear on the actuator that ultimately leads to its premature failure. This failure, in turn, increases maintenance to repair and/or replace components of the actuator or the actuator itself, increases down time of the associated machinery, and increases labor and/or operating costs for the overall manufacturing process. Also, during the transitional point, where slight fluid gland leaks have developed in multiple actuators during the same time period, and before maintenance takes place, excessive demand may be placed on the installation's fluid supply system. This, in turn, may have significant energy cost implications in, for example, replacing the wasted pressurized fluid.

Heretofore, a number of devices have been developed directed to excluding contaminants from the gland set entry point. For example, a convoluted bellows type of device has been used. These prior devices, however, lack sufficient durability and tend to have a short working life before maintenance is required. By way of example, these devices typically fracture through fatigue. Moreover, the fracture may remain undetected until irreparable damage has been done to the actuator. In addition, many of these prior devices have to “breathe” during the extending and retracting portions of the actuator cycle. As a result, these devices can ingest particles or contaminants in the surrounding environment, thereby nullifying their effectiveness unless, for example, extensive filtration is installed. For these reasons, the use of such devices is typically shunned by the industry.

Consequently, the industry is in need of an improved actuator that overcomes many of the drawbacks of conventional actuators to provide an increase in their working life. The increase in the working life of the actuator will in turn reduce maintenance, reduce down time of the machinery, and/or reduce operating costs.

### SUMMARY

To address these and other problems, an apparatus for an actuator, having an actuator housing and a movable shaft extending from the actuator housing, includes a housing having a central bore adapted to receive a portion of the shaft therethrough. The housing includes a fluid inlet port adapted to be coupled to a pressurized fluid supply for supplying a working fluid to the apparatus. The housing further includes a manifold chamber in fluid communication with the fluid inlet port and adapted to evenly distribute the working fluid to the apparatus. A plurality of bores are formed in the housing, each bore having a first end in fluid communication with the manifold chamber and a second end adapted to be adjacent the shaft such that the working fluid flowing through the bores impinges on the outer surface of the shaft. The bores are angled so as to produce a spiraling flow pattern about the shaft and therefore, more effectively remove particles therefrom. The bores may be circumferentially angled and may further be radially angled to produce the spiraling flow pattern.

In one embodiment, at least one groove may be formed in the central bore to operate as a back pressure relief mechanism. In another embodiment, a pressure chamber may be formed at least in part by the housing and at least one bore may be formed in the housing providing fluid communication between the pressure chamber and the manifold chamber. The bore not only provides relief for any back pressure that develops during operation of the actuator, but the bore also allows the lip pressure of the wiper of the gland set to be increased. In a further embodiment, increasing the lip pressure may be achieved by providing a pressure chamber, a second fluid inlet port adapted to be coupled to a pressurized fluid source, and a fluid channel providing fluid communication between the second fluid inlet port and the pressure chamber. In another embodiment, the fluid leaking past the gland set may be monitored by coupling the second fluid inlet port to a suitable measurement device. In still a further embodiment, a nose may extend from the housing so as to increase the distance between a terminating end of the nose and the location where the fluid flow impinges on the surface of the shaft.

The apparatus may further include a flow diverter adapted to be removably coupled to the housing in a spaced apart relationship to define a flow channel therebetween. The flow diverter directs the exhaust flow from the housing through the flow channel and away from the shaft. Another embodiment of a flow diverter includes a manifold chamber adapted to receive the exhaust flow from the housing, a fluid exit port, and a fluid channel providing fluid communication between the manifold chamber and the fluid exit port.

A method for removing particles from the surface of a shaft includes directing a flow of fluid onto the surface of the shaft in a generally spiraling flow pattern, and removing the particles from the shaft using the spiraling flow. The method may further include removing additional particles using the wiper from the gland set. Furthermore, the method may include providing the fluid flow at a temperature less than the temperature of the shaft and cooling the shaft using the flowing fluid.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective, partially dis-assembled view of an actuator utilizing a particle purge apparatus in accordance with an embodiment of the invention;

FIG. 2 is an assembled view of the actuator shown in FIG. 1;

FIG. 3 is a partial cross-sectional view of the actuator shown in FIG. 2 generally taken along line 3-3;

FIG. 4 is a front plan view of a portion of the particle purge apparatus;

FIG. 5 is partial cross-sectional view similar to FIG. 3 illustrating a spiraling flow pattern across the shaft;

FIG. 6 is a partial cross-sectional view similar to FIG. 3 illustrating another embodiment of a particle purge apparatus;

FIG. 7 is a partial cross-sectional view similar to FIG. 3 illustrating another embodiment of a particle purge apparatus;

FIG. 8 is a partial cross-sectional view similar to FIG. 3 illustrating another embodiment of a particle purge apparatus;

FIG. 9 is a partial cross-sectional view similar to FIG. 3 illustrating another embodiment of a particle purge apparatus; and

FIG. 10 is a partial cross-sectional view similar to FIG. 3 illustrating another embodiment of a particle purge apparatus.

### DETAILED DESCRIPTION

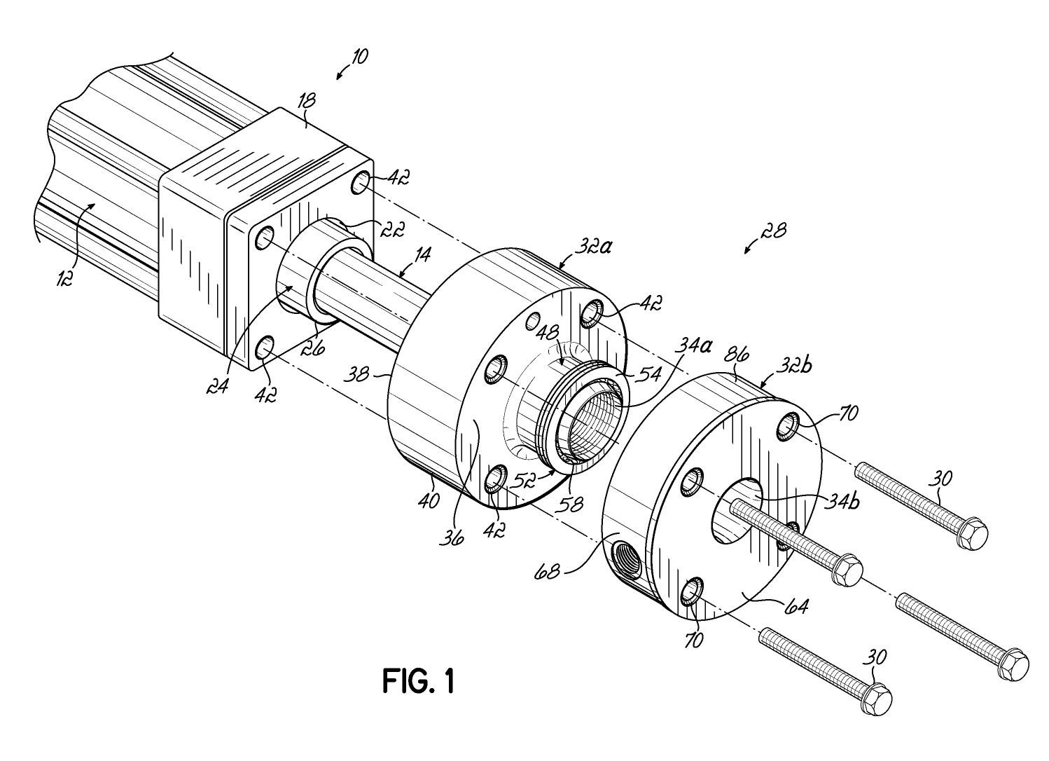

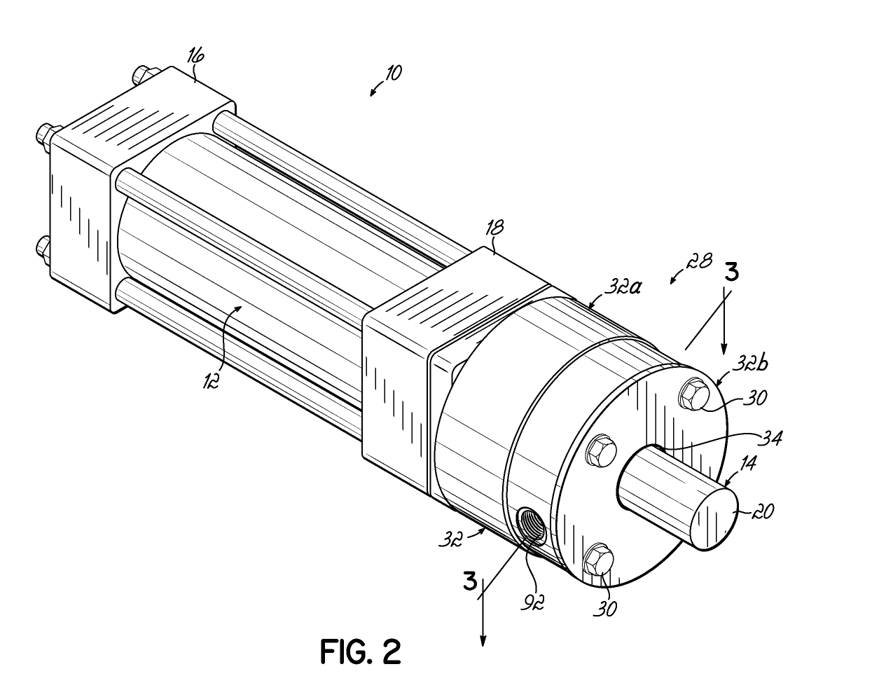

In reference to FIGS. 1 and 2, and in accordance with one embodiment of the invention, an actuator 10 is illustrated and includes an actuator housing 12 and a shaft 14 extending from the housing 12. As is conventional, the shaft 14 is capable of moving into and out of the housing 12 in a generally linear manner. The housing 12 includes a first end 16 and second end 18, and likewise, the shaft 14 includes a first end (not shown) and a second end 20. The first end 16 or the second end 18 of the housing 12 may be coupled to a support (not shown), such as by conventional mounting brackets, pivots, trunnions or any other type of mounting fasteners, to provide a fixed reference point. The first end of the shaft 14 is disposed within the housing 12 and is operatively coupled to a piston (not shown) for moving the shaft 14. The second end 18 of housing 12 includes an opening 22 adapted to receive a portion of shaft 14 therethrough and allows the shaft 14 to move relative to the housing 12. The second end 20 of shaft 14 may be coupled to a work piece (not shown) that is moved through activation of the actuator 10. The internal workings of the actuator 10 (e.g., piston, etc.) will not be described in detail herein as the general operation of the actuator is well understood in the art. The actuator 10 may encompass a broad range of actuators typically used in industry and include, for example, pneumatic and hydraulic type of linear actuators. Those of ordinary skill in the art may recognize other types of actuators that will benefit from aspects of the invention disclosed herein and aspects of the invention should not be limited to any particular type of actuator.

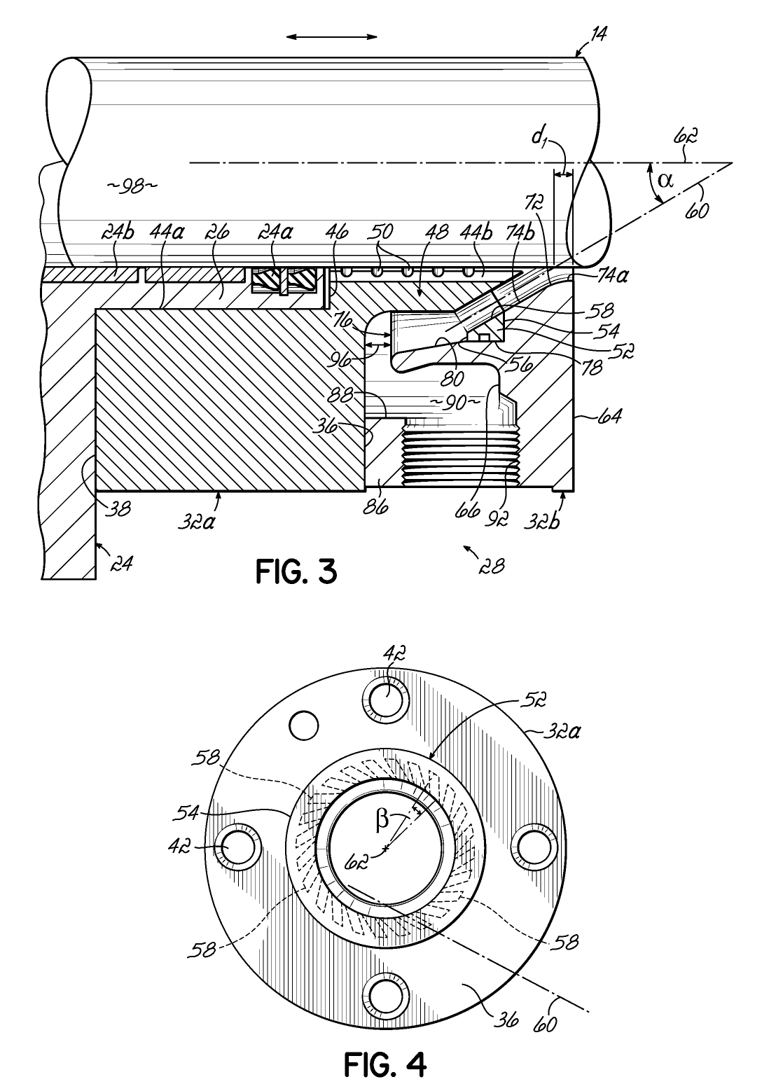

The actuator 10 includes a gland set 24 adjacent the opening 22 at the second end 18 of housing 12. In this embodiment, the gland set 24 may be of a convention design and adapted to isolate the inside of housing 12 from the external environment. In this way, for example, particles and other contaminants from the environment are prevented or restricted from entering the housing 12. Similarly, the gland set 24 prevents or reduces any fluid used in the actuator 10 from escaping the housing 12. As is generally known in the art, and as shown in FIGS. 3 and 6-10, the gland set 24 typically includes at least one wiper 24a, at least one bearing 24b, and at least one seal (not shown). In one embodiment, the gland set 24 may be disposed inside the housing 12 or alternatively, the gland set 24 may be a separate component that is removably coupled to the end of the housing 12, such as with one or more threaded fasteners or other suitable connectors. In any event, the gland set 24 may include a nose 26 that extends from the second end 18 of housing 12.

In one exemplary embodiment, the actuator 10 may include a particle purge apparatus 28 adapted to remove particles or other contaminants from the shaft 14 as the shaft 14 is being withdrawn into the housing 12. As discussed above, it is believed that the inability of the gland set 24 to more completely remove particles from the shaft 14 results in the premature failure of the actuator 10. The particle purge apparatus 28 is designed to remove particles from the shaft 14 before the shaft 14 comes into contact with the wiper(s) 24a of the gland set 24. In this way, there is essentially a two-stage process for removing particles from the shaft 14. It is further believed that such a two-stage process will extend the working life of the gland set 24 and therefore extend the working life of the actuator 10.

In one exemplary embodiment, and as shown in FIG. 2, the particle purge apparatus 28 may be adapted to be coupled to the second end 18 of the housing 12, such as by threaded fasteners 30. Other suitable fasteners, however, may be used to secure the particle purge apparatus 28 to the housing 12. In this regard, the particle purge apparatus 28 may operate as a retrofit device which may be implemented with existing actuator designs that are currently being sold and/or are already being used in the field. The invention, however, is not limited in use to a retrofit device. For example, in another embodiment in accordance with the invention, the particle purge apparatus 28 may be integrally incorporated into the housing of the actuator, such as during new actuator construction (not shown). In still another embodiment in accordance with the invention, the particle purge apparatus 28 may be integrally formed as part of a new gland set such that, in addition to the conventional components of the gland set, the new gland set will include the particle purge apparatus to provide a two-stage particle removing process (not shown). Thus, while a separate particle purge apparatus 28 will be described in detail herein, it should be realized that implementations of the apparatus 28 within existing actuators and/or their components are within the scope of the present invention.

As shown in FIGS. 1-3, the particle purge apparatus 28 includes a generally cylindrical housing 32 having a central bore 34 adapted to receive the shaft 14 therethrough. While the housing 32 is shown as being generally cylindrical, those of ordinary skill in the art will recognize that other shapes (square, rectangle, etc.) may also be used. In an exemplary embodiment, the housing 32 may have a two-part construction including a body portion 32a and a cover portion 32b, each having a respective bore 34a, 34b for receiving the shaft 14. The housing 32 may be formed from any suitable material able to withstand the harsh environment in which the actuator 10 is being operated. For example, the housing 32 may be formed from any ferrous or non-ferrous material and includes, without limitation, steel, aluminum, brass, bronze, and in some applications, even one or more suitable engineering plastics. Other alloys of the materials mentioned above might prove suitable, or combinations of various materials may also be possible depending on the specific application.

The body portion 32a includes a first face 36, a second face 38, and a side wall 40 extending therebetween. Those of ordinary skill in the art will recognize that the size and/or length of body portion 32a may be selected for specific applications. One or more bores 42 extend through the body portion 32a and are open to the first and second faces 36, 38 so as to receive fasteners 30. The housing 12 of actuator 10 includes threaded bores 42 for receiving fasteners 30 to secure the body portion 32a to housing 12. The bore 34a through body portion 32a has a stepped configuration defining a first bore portion 44a, a second bore portion 44b, and a shoulder 46 therebetween. The first bore portion 44a is slightly enlarged relative to second bore portion 44b so as to receive the nose 26 of gland set 24 therein and providing relatively accurate concentricity between the components. The end of nose 26 may be adjacent or contact shoulder 46. The second face 38 of body portion 32a is adapted to confront and/or contact the second end 18 of housing 12 when coupled thereto.

As shown in FIGS. 1 and 3, body portion 32a includes a nose 48 extending from first face 36 and through which second bore portion 44b extends. The second bore portion 44b is sized to closely receive shaft 14 therethrough. For purposes discussed in detail below, the second bore portion 44b may include one or more grooves 50 formed in the surface thereof. The groove(s) 50 may be one continuous spiraling groove or, alternatively, a plurality of spaced apart grooves, commonly known as labyrinth seal grooves, the design of which is well known in the art, or combinations thereof. The outer end portion of nose 48 away from face 36 includes a radially outwardly extending flange or lip 52 having a first face 54 and a second face 56. The lip 52 includes a plurality of bores 58 extending from first face 54 to second face 56 and through lip 52, and circumferentially spaced therealong. Each of the bores 58 intersects the first face 54 at a location that is radially closer to shaft 14 than the location of where the bores 58 intersect the second face 56. This is referred to herein as radial angling of the bores 58. In this way, an acute angle α is defined between the centerline 60 of the bores 58 and the centerline 62 of shaft 14, when viewed from the perspective shown in FIG. 3.

In addition to this radial angling, the bores 58 may also be configured to have what is referred to herein as circumferential angling. In this regard, and as illustrated in FIG. 4, each of the bores 58 intersects the first face 54 at a first circumferential location, and intersects the second face 56 at a second circumferential location that is different than the first circumferential location to define an acute angle β. In this way, the centerline 60 of the bores 58 and the centerline 62 of shaft 14 do not intersect when viewed from the perspective shown in FIG. 4. The purpose of the radial and circumferential angling of the bores 58 will be explained in more detail below.

As noted above, and as shown in FIGS. 1-3, the housing 32 further includes a cover portion 32b that is secured to body portion 32a. The cover portion 32b includes a first face 64, a second face 66, and a side wall 68 extending therebetween. Those of ordinary skill in the art will recognize that the size and/or length of cover portion 32b may be selected for specific applications. One or more bores 70 extend through the cover portion 32b and are open to the first and second faces 64, 66 so as to receive fasteners 30. As shown in FIG. 1, the same fasteners 30 that secure the body portion 32a to housing 12 may also be used to secure the cover portion 32b to body portion 32a. Alternatively, however, the fasteners that secure the body portion 32a to housing 12 may be separate from the fasteners that secure the cover portion 32b to body portion 32a (not shown). The bore 34b through cover portion 32b is defined by a generally arcuate surface 72 that decreases the radial extent of the bore 34b (e.g., its diameter) in a direction from second face 66 toward first face 64. By way of example, the bore 34b may include a generally radiused first bore portion 74a and a generally linear second bore portion 74b. Other configurations, however, are also possible. For example, a series of one or more smoothly connecting conical bores of different angularity may be used to replace the arcuate configuration of 74a. Nevertheless, the first bore portion 74a is configured such that the intersection between the bore 74a and first face 64 is radially spaced from the shaft 14. This defines a gap or exit through which the fluid flow is exhausted. The second bore portion 74b is configured to generally align with and mate with the bores 58 in the body portion 32a.

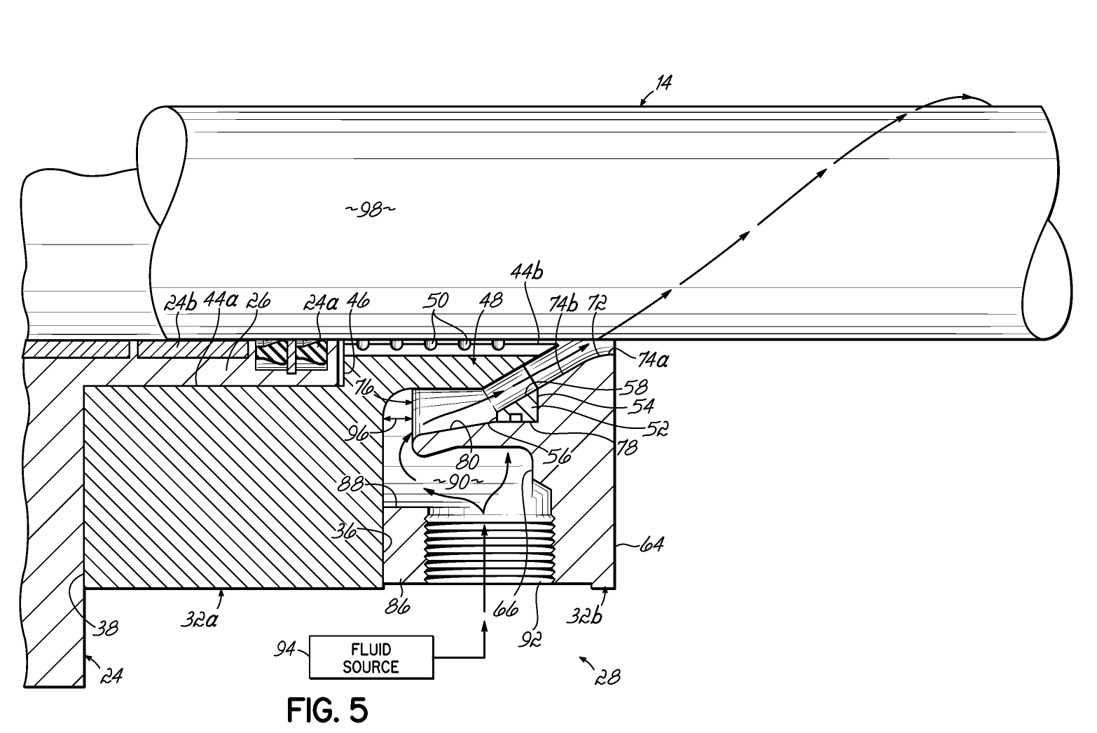

As shown in FIG. 3, the cover portion 32b includes a nose 76 extending away from the second face 66 and spaced radially of bore 34b in cover portion 32b. In this regard, the nose 76 is sized so as to tightly receive the nose 48 of body portion 32a therein. An interior surface of nose 76 includes a generally linear portion 78 and a generally diverging portion 80. The lateral edge of lip 52 of nose 48 is configured to mate with the linear portion 78 of nose 76. To facilitate a fluid tight seal between the nose 48 of body portion 32a and the nose 76 of cover portion 32b, an O-ring or other seal member may be disposed in a groove in an outer edge of lip 52 or disposed along the first face 54 of lip 52. Additionally, the cover portion 32b may include an annular ring 86 extending away from the second face 66 and adjacent the side wall 68. The inner wall 88 of the annular ring 86 is configured to be at a radial dimension greater than the nose 76. Such a configuration defines a manifold chamber 90 about nose 76, the purpose of which is described in more detail below. A fluid inlet port 92 extends into the annular ring 86 and is in fluid communication with the manifold chamber 90. The fluid inlet port 92 is adapted to be in fluid communication with a pressurized fluid source 94 (FIG. 5), via a suitable conduit line for supplying a working fluid to particle purge apparatus 28.

In reference to FIG. 5, operation of the particle purge apparatus 28 will now be described. During operation of the actuator 10, particles and other contaminants are deposited on the extended portion of the shaft 14 outside of housing 12. Pressurized fluid from fluid source 94 is supplied to the fluid inlet port 92 in cover portion 32b. The working fluid may be a gas or a liquid, depending on the specific application, but preferably is air. The fluid supplied to fluid inlet port 92 enters the relatively low pressure manifold chamber 90, where the fluid is substantially evenly distributed in the circumferential direction around the chamber 90. The manifold chamber 90 also operates to dampen out any fluctuations in the fluid flow resulting in more steady operation of the apparatus 28. The fluid enters the nose 76 via a gap 96 between the end of the nose 76 and the first face 36 of body portion 32a and accelerates as it moves along the (now converging) portion 80 of nose 76 and toward the bores 58. The fluid enters the plurality of bores 58 and is directed so as to impringe on the outer surface 98 of shaft 14.

The radial angling of the bores 58 results in a first component of the fluid flow being in the radial direction (e.g., directed radially inward toward the shaft 14) and a second component in the longitudinal direction (e.g., directed along the length of the shaft 14 and away from the apparatus 28). Moreover, the circumferential angling of the bores 58 results in the fluid flow having a third component in the circumferential or azimuthal direction relative to shaft 14. These flow components combine to give a spiraling flow pattern about shaft 14, as best shown in FIG. 5.

Without limitation, it is believed that a spiraling flow pattern about shaft 14 is more efficient at removing particles from shaft 14 as compared to other flow patterns. One reason for the improved efficiency may be due to the conventional manufacturing process of the actuator shaft. In this regard, the shafts may be formed or polished using any one of a number of machining/fine-finishing processes where the shafts are turned about its central axis or centerline 62. Accordingly, the microstructure (e.g., peaks and valleys) on the outer surface of the shaft tend to be arranged in a spiraling pattern. Thus, particles which reside in the valleys of the microstructure may be more easily removed from the shaft if the fluid flows in the direction of the valleys (e.g., spiraling pattern) as opposed to flow across the valleys (e.g., primarily in the longitudinal direction) and without any circumferential component thereto.

In addition to the above, another beneficial aspect of particle purge apparatus 28 is that it has no moving parts, which is in contrast to existing devices (e.g., bellows). With no moving parts, the apparatus 28 essentially has an infinite working life. In another beneficial aspect, the size of the bores/orifices in partricle purge apparatus 28 are such as to make the likelihood of clogging of the device relatively low.

As discussed above, the second bore portion 44b of bore 34a in body portion 32a normally includes one or more grooves 50. During operation of the actuator 10, and as the gland set 24 starts to wear, fluid may leak out of the housing 12. As a result, a back pressure may be generated between the gland set 24 and the particle purging apparatus 28. The grooves 50 are configured to partially assist in the retention of the fluid which leaks passed the gland set 24 according to the principle of the labyrinth seal groove technique. This increased pressure acts upon the lips of the wiper(s) 24a and increases the force with which they engage the outer surface 98 of shaft 14, thereby increasing the efficiency of the wiper(s) 24a. Such an arrangement is self-balancing in the sense that the greater the fluid leakage from gland set 24 the more the pressure will build up to increase the pressure on the lips of the wiper(s) 24a. The labyrinth seal groove 50 will, however, allow a certain amount of fluid to pass therethrough such that the pressure on the lips of the wiper(s) 24a does not become excessive. The fluid which has traversed the grooves 50 will simply pass to waste with the fluid flow from apparatus 28.

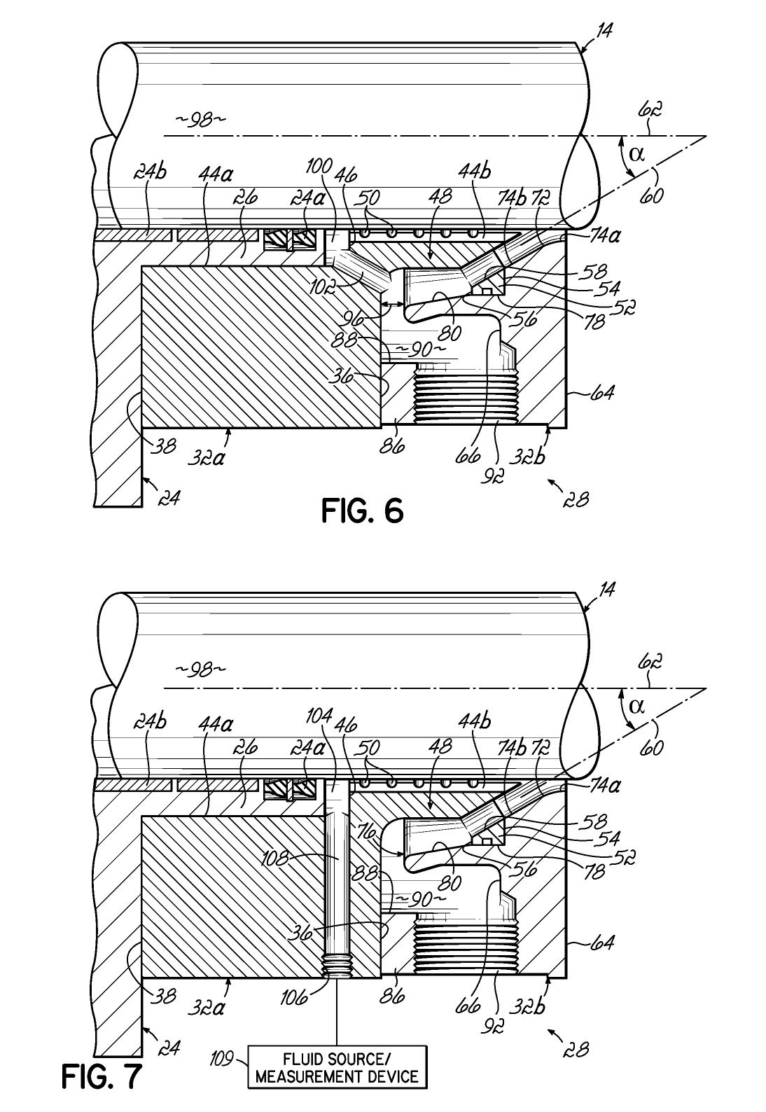

FIG. 6, in which like reference numerals refer to like features in FIGS. 1-5, illustrates an alternative embodiment for releasing back pressure that develops in actuator 10. In this regard, the housing 32 may be configured to define a pressure chamber 100 between the housing 32 and the gland set 24. One or more circumferentially spaced bores 102 may be formed in the body portion 32a that provides fluid communication between the manifold chamber 90 and the pressure chamber 100. In this way, any pressure increase in chamber 100 that rises above the pressure maintained in the manifold chamber 90 may be relieved by flow through the bore(s) 102, thereby avoiding excessive back pressure on the gland set 24 or particle purge apparatus 28. In addition to the above, the bore(s) 102 allow the pressure chamber 100 to be pressurized up to the pressure of manifold chamber 90. This pressure may be utilized to increase the lip pressure on the wiper 24a of gland set 24 and thereby gain additional wiper-to-shaft contact. In this embodiment, the groove(s) 50 may be included or omitted (grooves shown in FIG. 6).

In some applications, it may be advantageous to provide a pressure chamber about the gland set 24 that is independent or isolated from the manifold chamber 90. In this regard, and as illustrated in FIG. 7, in which like reference numerals refer to like features in FIGS. 1-5, a pressure chamber 104 may be defined between the housing 32 and gland set 24, similar to the previous embodiment. However, in this embodiment, the pressure chamber 104 may be coupled to a second fluid inlet port 106 in the body portion 32a via flow channel 108. The second fluid inlet port 106 may be coupled to fluid source 94 or be coupled to a second, separate fluid source 109 (FIG. 7) that can be controlled separately from fluid source 94. Alternatively, various valves or other controls may be used to control the pressure in chamber 104 when coupled to source 94. Similar to the previous embodiment, the pressure in chamber 104 may be utilized to increase the lip pressure on the wiper 24a of gland set 24, and thereby gain additional wiper-to-shaft contact. In this embodiment, any back pressure may be relieved via the groove(s) 50, as discussed above.

In an alternative embodiment, the chamber 104 and port 106 may be used to monitor any leakage of fluid past the gland set 24. In this embodiment, the port 106 may be coupled to a measurement device 109 capable of indicating leakage past gland set 24. In one embodiment, the measurement device 109 may include a pressure gage (e.g., pressure transducer) that monitors the back pressure. When the back pressure exceeds a specified threshold, an alarm condition may be indicated to the user or operator. Alternatively, the measurement device 109 may include a flow meter to directly quantify the amount of fluid that leaks past gland set 24. Again, if the flow exceeds a specified amount, an alarm condition may be indicated. Those of ordinary skill in the art may recognize other devices which can be used to identify a leak of fluid past the gland set 24.

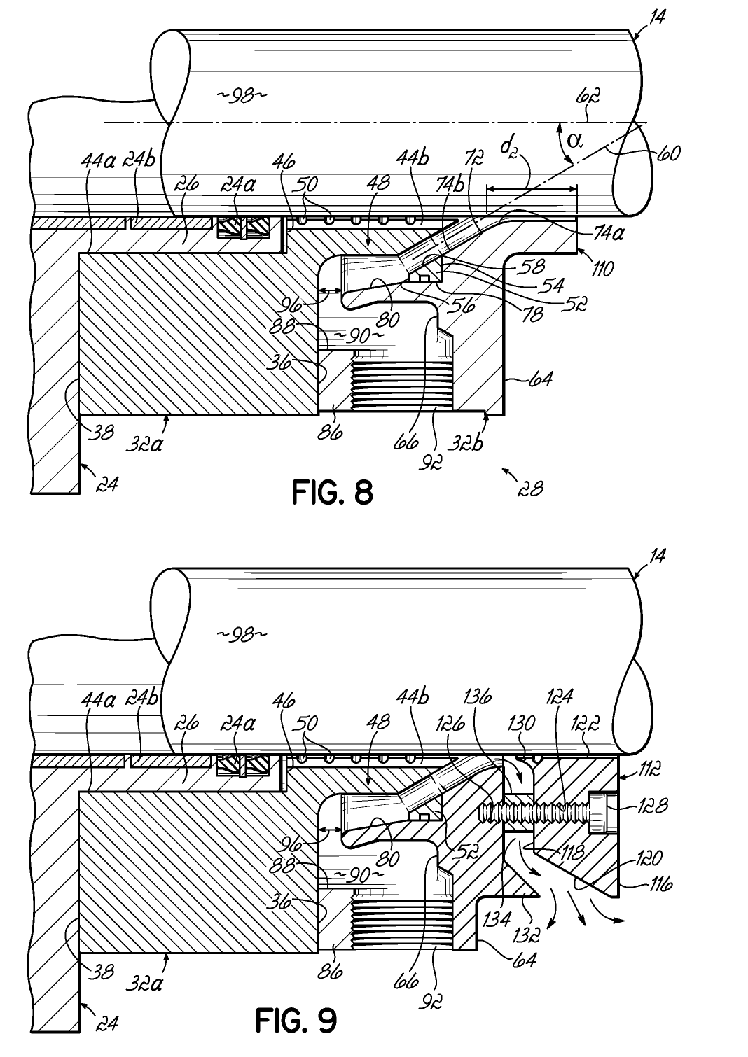

FIG. 8, in which like reference numerals refer to like features in FIGS. 1-5, illustrates another embodiment in accordance with the invention for improving the efficiency of particle removal from the shaft 14. In this regard, it is believed that the efficiency of particle removal from the shaft 14 may be increased for an increased length over which the spiraling flow from particle purge apparatus 28 is constrained to be in close proximity about the shaft 14. To this end, the first face 54 of cover portion 32b may include a nose 110 extending therefrom. Referring back to FIG. 3, where there is no nose, the centerline 60 of the bores 58 intersect the shaft 14 at a distance d₁ from the end of cover portion 32b. For example, the distance d₁ may be between two percent and fifty percent of the diameter of the shaft 14. The inclusion of nose 110 may extend this distance. More particularly, as shown in FIG. 8, the distance d₂ between the intersection of centerline 60 of the bores 58 and the shaft 14 and the end of nose 110 may be between one and two times the diameter of the shaft 14. These ranges are exemplary and those of ordinary skill in the art will recognize how to vary this distance to achieve the desired efficiency.

FIG. 9, in which like reference numerals refer to like features in FIGS. 1-5, illustrates yet another embodiment in accordance with the invention. In some applications, it may be undesirable to allow the exhausted fluid flow from the particle purge apparatus 28 to freely flow along the exposed shaft 14 or surrounding environment without any restrictions. By way of example, there may be adjacent machinery or processes for which flow disturbances are undesirable. In such applications, the exhausted fluid flow from particle purge apparatus 28 should be isolated or contained to the immediate vicinity of the apparatus 28. In this regard, the housing 32 of apparatus 28 may include a flow diverter, generally shown at 112 adapted to deflect the flow radially outward and away from the shaft 14. In this regard, the flow diverter 112 may include a first face 116, a second face 118, and a side wall 120 extending therebetween. A central bore 122 may be formed therein adapted to receive the shaft 14 therethrough. The central bore 122 may or may not include one or more labyrinth seal grooves 50. The flow diverter 112 may include one or more bores 124 and the first face 64 of cover portion 32b may include one or more threaded bores 126, wherein bores 124, 126 are adapted to receive a threaded fastener 128 therethrough for securing the flow diverter 112 to the cover portion 32b of housing 32. The bores 124 may be configured to receive the head of threaded fastener 126 in a counter sunk manner, as is generally known in the art.

The second face 118 of the flow diverter 112 may include a lip 130 adjacent the central bore 122 to facilitate in diverting the flow from apparatus 28. Similarly, the side wall 120 of flow diverter 112 may be angled or beveled to guide the exhausted flow in a certain direction away from apparatus 28. The first face 64 of cover portion 32b may also include lip 132 adjacent an outer edge thereof that cooperates with the beveled side wall 120 of flow diverter 112 to likewise channel the flow in a certain direction away from apparatus 28. The width of the diverting flow channel 134 (e.g., the space between the cover portion 32b and the flow diverter 112) may be selectively varied. In this regard, the flow diverter 112 may include a spacer 136 inserted or threaded over one or more of threaded fasteners 128. The length of the spacer 136 dictates the width of the flow channel 134 and may be appropriately selected for the specific application.

In use, when the fluid flows out of bores 58, it flows around the shaft 14 in the spiraling pattern as described above. The fluid exits the particle purge apparatus 28 and contacts the lip 130 projecting from the second face 118 of the flow diverter 112 so as to divert the fluid flow into the channel 134. The flow then contacts the lip 132 on the first face 64 of cover portion 32b to turn the flow so as to exit the channel 134 in the desired manner. The use of flow diverter 112 provides some control on the exhausted fluid flow from particle purge apparatus 28 and may minimize any disturbances or other undesired effects in machinery or processes in the immediate vicinity of the apparatus 28.

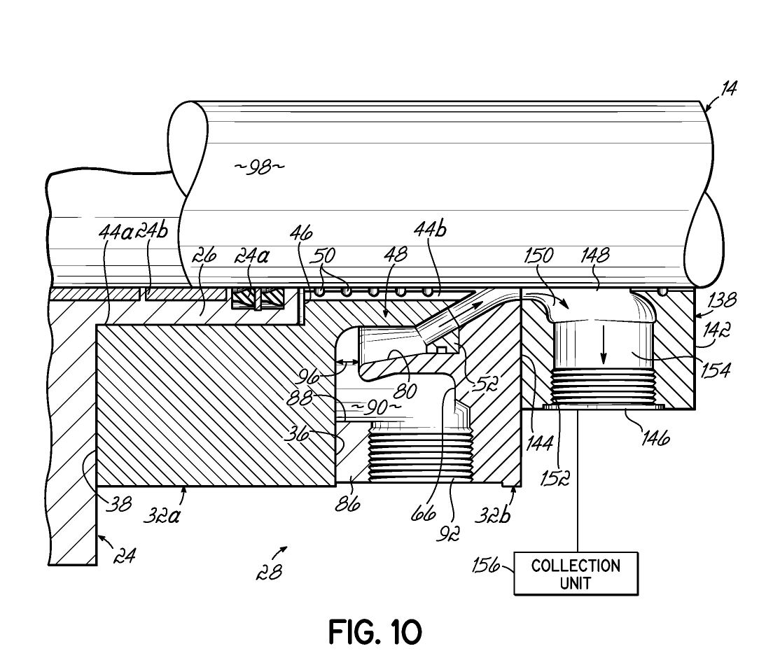

FIG. 10, in which like reference numerals refer to like features in FIGS. 1-5, illustrates another embodiment in accordance with the invention similar to that shown in FIG. 9. In this regard, the embodiment shown in FIG. 10 is also directed to exerting some control on the fluid flow exhausted from housing 32. In this regard, the apparatus 28 may include a flow diverter 138 including a first face 142, a second face 144, and a side wall 146 extending therebetween. A central bore 148 may be formed therein adapted to receive the shaft 14 therethrough. The flow diverter 138 may be integrally formed with the housing 32, and more particularly, cover portion 32b. Alternatively, the flow diverter 138 may be coupled to the cover portion 32b using one or more threaded fasteners (not shown).

The central bore 148 is enlarged adjacent the second face 144 of flow diverter 138 so as to define a manifold chamber 150 that extends around shaft 14. The flow diverter 138 includes a fluid exit port 152 that is in fluid communication with the manifold chamber 150 via fluid channel 154. The fluid exit port 152 is in fluid communication, such as with suitable conduit lines, with an exhaust collection unit, schematically shown at 156. In one embodiment, the collection unit 156 may contain the exhausted flow for treatment and reuse of the fluid. Alternatively, the collection unit may vent the exhausted flow to the environment, but at a location away from the actuator 10 and the various machinery and processes occurring thereby.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. For example, as mentioned above, while the particle purge apparatus was shown and described herein as a retrofit type of device, it may be incorporated into the actuator or gland set in, for example, new actuator construction.

Moreover, while the primary focus was the removal of particles from the shaft, another aspect of the invention is that the apparatus may also be used to cool the surface temperature of the shaft. In this regard, the working fluid may be provided at a temperature less than the shaft temperature. Directing this cooler fluid over the shaft in a spiraling fashion extends the amount of time that the fluid is in contact with the outer surface of the shaft relative to the contact time characterized by straight, linear fluid flow, thereby producing an enhanced cooling effect. This cooling may help prevent overheating caused by internal friction of the actuator, the apparatus, or external processes near the shaft 14 outside the housing 12. A lower operating temperature may also increase the life cycle of the gland set 16. Thus, there may be other uses of the apparatus that provide benefits to applications utilizing actuators.

Furthermore, while the pressurized fluid for the particle purging apparatus 28 was supplied as a new or clean fluid from fluid source 94, the pressurized fluid for operating apparatus 28 may come from the waste or exhaust fluid from the actuator housing. In the normal course, to move the shaft of the actuator back into the housing, the pressure acting on the back side of the piston is increased relative to the pressure acting on the front side. As the piston moves, the pressure on the front side increases and must be vented for continued movement of the piston. To this end, the fluid on the front side of the piston is typically vented to the environment. In an alternative embodiment, the fluid on the front side of the piston may be ported to particle purge apparatus 28 as the working fluid during the back stroke of the piston. Such an embodiment gets the benefits of the particle purge apparatus at little to no additional expense (e.g., essentially free pressurized fluid source).

Accordingly, the various features of the invention may be used alone or in any combination depending on the needs and preferences of the user. This has been a description of the present invention, along with the preferred embodiments and methods of practicing the present invention, as currently known. However, the invention itself should only be defined by the appended claims. What is claimed is:

1. An apparatus for an actuator having an actuator housing and a movable shaft extending from the actuator housing, comprising:
a housing having a central bore adapted to receive a portion of the shaft therethrough, the housing comprising;
a fluid inlet port adapted to be coupled to a pressurized fluid supply for supplying a working fluid to the apparatus;
a manifold chamber in fluid communication with the fluid inlet and adapted to evenly distribute the working fluid about the shaft; and
a plurality of bores each having a first end and a second end, the first end of the bores in fluid communication with the manifold chamber and the second end of the bores adapted to be adjacent the shaft such that the working fluid flowing through the bores impinges on an outer surface of the shaft,
wherein the bores are angled to produce a spiraling flow pattern about the shaft in order to remove particles therefrom.

2. The apparatus of claim 1, wherein the bores are circumferentially angled to produce the spiraling flow pattern about the shaft.

3. The apparatus of claim 1, further comprising:
at least one groove formed in a surface defining the central bore.

4. The apparatus of claim 1, further comprising:
a pressure chamber formed at least in part by the housing; and
at least one bore formed in the housing having a first end in fluid communication with the pressure chamber and a second end in fluid communication with the manifold chamber.

5. The apparatus of claim 1, further comprising:
a pressure chamber formed at least in part by the housing;
a second fluid inlet port adapted to be coupled to a pressurized fluid supply for supplying a working fluid to the apparatus; and
a fluid channel having a first end in fluid communication with the second fluid inlet port and a second end in fluid communication with the pressure chamber.

6. The apparatus of claim 1, further comprising:
a chamber formed at least in part by the housing;
a second port adapted to be coupled to a measurement device for monitoring fluid leaks past the actuator housing; and
a fluid channel having a first end in fluid communication with the second port and a second end in fluid communication with the chamber.

7. The apparatus of claim 1, further comprising:
a nose extending from the housing and having a terminating end, wherein the working fluid impinges on the outer surface of the shaft at a location that is spaced from the terminating end of the nose.

8. The apparatus of claim 1, further comprising:
a flow diverter adapted to be removably coupled to the housing in a spaced apart relationship to define a flow channel therebetween, the flow diverter adapted to divert the fluid exiting the housing away from the shaft.

9. The apparatus of claim 1, further comprising:
a flow diverter coupled to the housing, the flow diverter comprising:
a manifold chamber adapted to receive the fluid exiting the housing;
a fluid exit port adapted to be in fluid communication with a fluid collection unit; and
a fluid channel having a first end in fluid communication with the manifold chamber and a second end in fluid communication with the fluid exit port, the flow diverter adapted to transport the fluid exiting the housing away from the actuator.

10. An actuator, comprising:
an actuator housing;
a shaft extending from the actuator housing and movable relative thereto; and
a particle purge apparatus, comprising:
a housing having a central bore through which the shaft extends, the housing comprising;
a fluid inlet port adapted to be coupled to a pressurized fluid supply for supplying a working fluid to the apparatus;
a manifold chamber in fluid communication with the fluid inlet to evenly distribute the working fluid about the shaft; and
a plurality of bores each having a first end and a second end, the first end of the bores in fluid communication with the manifold chamber and the second end of the bores adjacent the shaft such that the working fluid flowing through the bores impinges on an outer surface of the shaft,
wherein the bores are angled to produce a spiraling flow pattern about the shaft in order to remove particles therefrom.

11. The actuator of claim 10, wherein the bores are circumferentially angled to produce the spiraling flow pattern about the shaft.

12. The actuator of claim 10, further comprising:
at least one groove formed in a surface defining the central bore.

13. The actuator of claim 10, further comprising:
a pressure chamber formed at least in part by the housing; and
at least one bore formed in the housing having a first end in fluid communication with the pressure chamber and a second end in fluid communication with the manifold chamber.

14. The actuator of claim 10, further comprising:
a pressure chamber formed at least in part by the housing;
a second fluid inlet port adapted to be coupled to a pressurized fluid supply for supplying a working fluid to the apparatus; and
a fluid channel having a first end in fluid communication with the second fluid inlet port and a second end in fluid communication with the pressure chamber.

15. The actuator of claim 10, further comprising:
a nose extending from the housing and having a terminating end, wherein the working fluid impinges on the outer surface of the shaft at a location that is spaced from the terminating end of the nose.

16. The actuator of claim 10, further comprising:
a flow diverter adapted to be removably coupled to the housing in a spaced apart relationship to define a flow channel therebetween, the flow diverter adapted to divert the fluid exiting the housing away from the shaft.

17. The actuator of claim 10, further comprising:
a flow diverter removably coupled to the housing, the flow diverter comprising:
a manifold chamber adapted to receive the fluid exiting the housing;
a fluid exit port adapted to be in fluid communication with a fluid collection unit; and
a fluid channel having a first end in fluid communication with the manifold chamber and a second end in fluid communication with the fluid exit port, the flow diverter adapted to transport the fluid exiting the housing away from the actuator.

18. The actuator of claim 10, wherein the particle purge apparatus is integrally formed with the actuator.

19. The actuator of claim 10, further comprising:
a gland set coupled to the actuator and configured to isolate the inside of the actuator housing from the environment,
wherein the particle purge apparatus is integrally formed with the gland set.

20. A method for removing particles from the surface of a shaft, comprising:
directing a flow of a fluid onto the surface of the shaft in a generally spiraling pattern; and
removing particles from the shaft using the spiraling flow.

21. The method of claim 20, further comprising:
removing particles from the shaft using a wiper of a gland set.

22. The method of claim 20, further comprising:
diverting the fluid flow away from the shaft.

23. The method of claim 20, further comprising:
providing the fluid flow at a temperature less than the temperature of the shaft; and
cooling the shaft by directing the flow of fluid over the shaft.
